(19) United States
(12) Patent Application Publication
(10) Pub. No.: US 2015/0036865 A1
(43) Pub. Date: Feb. 5, 2015

(54) ELECTRICAL SIGNAL TO AUDIO SIGNAL TRANSDUCER WITH A DEFORMABLE DIAPHRAGM UNIT

(71) Applicant: Lai-Shi Huang, New Taipei City (TW)

(72) Inventor: Lai-Shi Huang, New Taipei City (TW)

(21) Appl. No.: 13/954,327

(22) Filed: Jul. 30, 2013

(51) Int. Cl. H04R 7/16

(52) U.S. Cl. CPC H04R 7/16
USPC 381/398

(57) ABSTRACT

An electrical signal to audio signal transducer with a deformable diaphragm unit includes a connective portion and a deformable diaphragm unit. The connective portion connects the deformable diaphragm unit with a wall of a box. The deformable diaphragm unit is linked up with a through opening of the connective portion to form a passage. Push and pull exerted on the deformable diaphragm unit by the magnetic force induced by the current flows through the voice coil can cause deformable diaphragm unit to deform and move in a reciprocating manner and thus generate audible sounds. Therefore, with the transducer of the present invention, poor performance due to the dimensional constrain may be overcome.

### BACKGROUND OF THE INVENTION

1. Field of the Invention

The invention generally relates to an electrical signal to audio signal transducer. More particularly, the invention relates to an electrical signal to audio signal transducer that is characterized with a higher efficiency and a smaller width.

2. Description of the Prior Art

As of now, loudspeakers may be categorized into six types: moving coil driver, electrostatic driver, ribbon driver, electric arc driver and piezoelectric film driver and electret driver. Speaker of electrostatic driver requires a high voltage. Ribbon driver can not generate low-frequency sounds. Electric arc driver generates toxic gases. Piezoelectric film speaker requires a special circuit and can not generate low-frequency sounds. Electret driver requires a bigger space and can not generate low-frequency sounds. Therefore, the most common type is moving coil driver in which audible sounds are generated by a voice coil and a diaphragm fitted to a truncated cone-shaped basket.

In a moving coil speaker, a voice coil is disposed near a magnet. As current flows through the voice coil, a magnetic field is induced. Then this magnetic field interacts with the magnetic field of the magnet. The result of this interaction causes the voice coil and a diaphragm attached to the voice coil to move back and forth to generate audible sounds.

Modern electronic products (such as mobile phones, tablet computers and notebook computers) become thinner and more compact. In the moving coil speakers, magnet has to be made smaller and this would result in poor performance. In addition, because the area of displacement of a diaphragm in its reciprocating motion corresponds to the magnitude of the audible sounds generated by the diaphragm, the dimensional constrain would adversely affect the amplitude.

### SUMMARY OF THE INVENTION

The object of the present invention is to provide an electrical signal to audio signal transducer that can enhance performance.

To reach the object, the electrical signal to audio signal transducer with a deformable diaphragm unit of the present invention is disclosed. The electrical signal to audio signal transducer of the present invention comprises a connective portion and a deformable diaphragm unit. A through opening is provided in the connective portion. The outer side of the connective portion is connected with the wall of a box. The outer side of the deformable diaphragm unit is connected with the through opening of the connective portion, and the inner side of the deformable diaphragm unit is connected with a voice coil. Push and pull exerted on the deformable diaphragm unit by the magnetic force induced by the current flows through the voice coil can cause the deformable diaphragm unit to deform and move in a reciprocating manner and thus generate audible sounds.

### BRIEF DESCRIPTION OF THE DRAWINGS

FIG. 1 is a perspective view illustrating the electrical signal to audio signal transducer with a deformable diaphragm unit of the present invention.

FIG. 2 is another perspective view illustrating the electrical signal to audio signal transducer with a deformable diaphragm unit of the present invention.

FIG. 3 is a side view of the first embodiment of the present invention.

FIG. 4 is a side view illustrating the deformable diaphragm unit is pushed and contracted by the voice coil in the second embodiment of the present invention.

FIG. 5 is a side view illustrating the deformable diaphragm unit is pulled and extended by the voice coil in the second embodiment of the present invention.

FIG. 6 is a diagram schematically illustrating the area of displacement of the moving coil of the prior art speaker.

FIG. 7 is a diagram schematically illustrating the area of displacement of the transducer of the present invention.

FIG. 8 is a perspective view illustrating a third embodiment of the transducer of the present invention.

FIG. 9 is a diagram schematically illustrating the area of displacement in the third embodiment and in the moving coil speaker of the prior art.

### DETAILED DESCRIPTION OF THE PREFERRED EMBODIMENTS

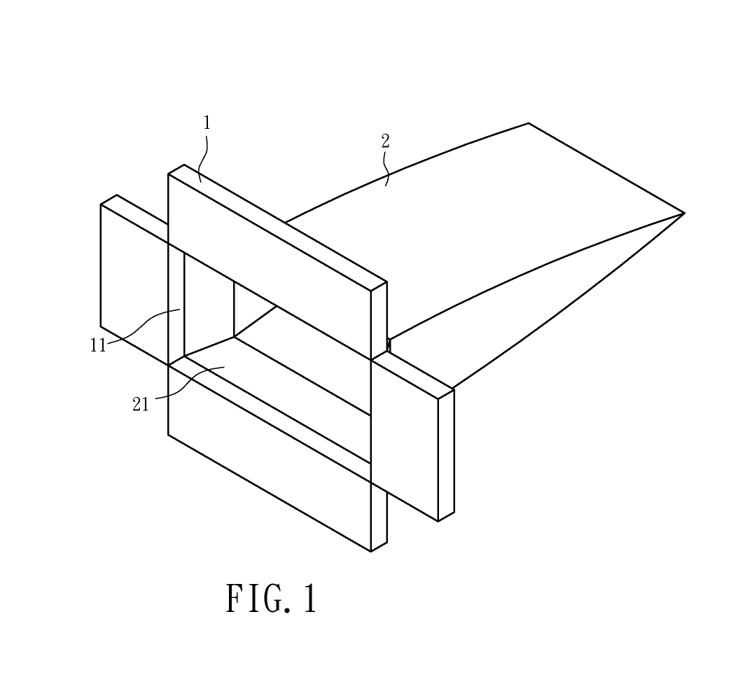

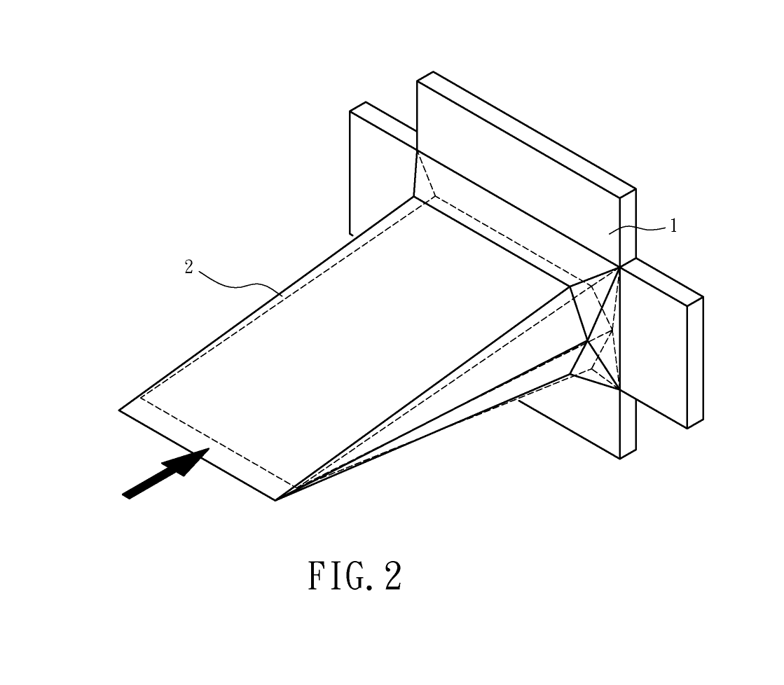

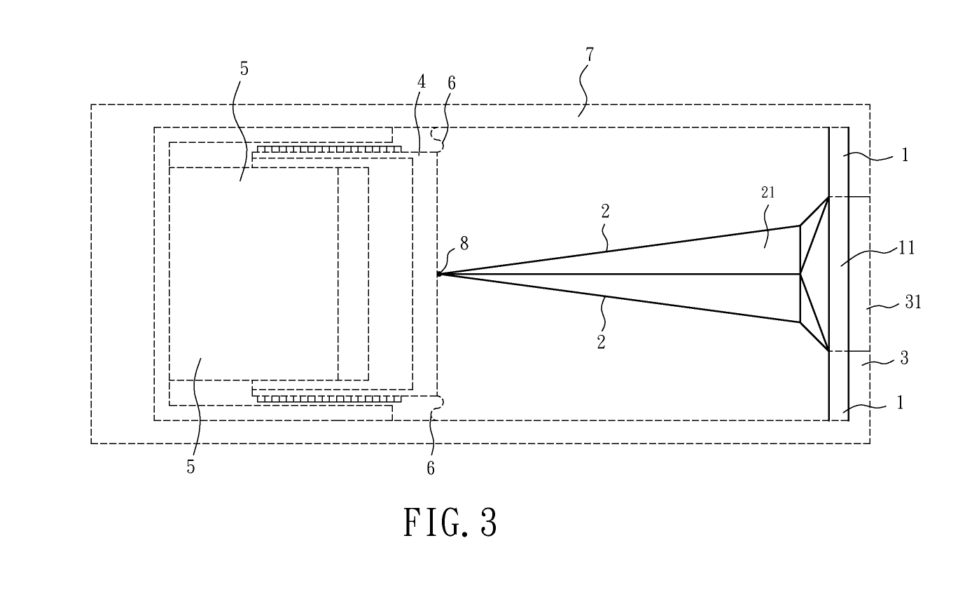

Please refer to FIGS. 1, 2 and 3. The electrical signal to audio signal transducer with a deformable diaphragm unit of the present invention comprises a connective portion 1 and a deformable diaphragm unit 2. A through opening 11 is provided in the connective portion 1, and the outer side of the connective portion 1 is connected with the wall 3 of a box 7. The inner side of the connective portion 1 is connected with the deformable diaphragm unit 2 to form a path 21. One side of the deformable diaphragm unit 2 is connected with the through opening 11, and the other side of the deformable diaphragm unit 2 is connected with a voice coil 4 at at least an affixing point 8, which is formed by glue or soldering. The deformable diaphragm unit 2 comprises at least one diaphragm and is a partial enclosure entity. An opening 31 is provided in the wall 3 of the box 7. When the connective portion 1 is connected with the wall 3, the through opening 11 should be aligned with the opening 31 of the wall 3.

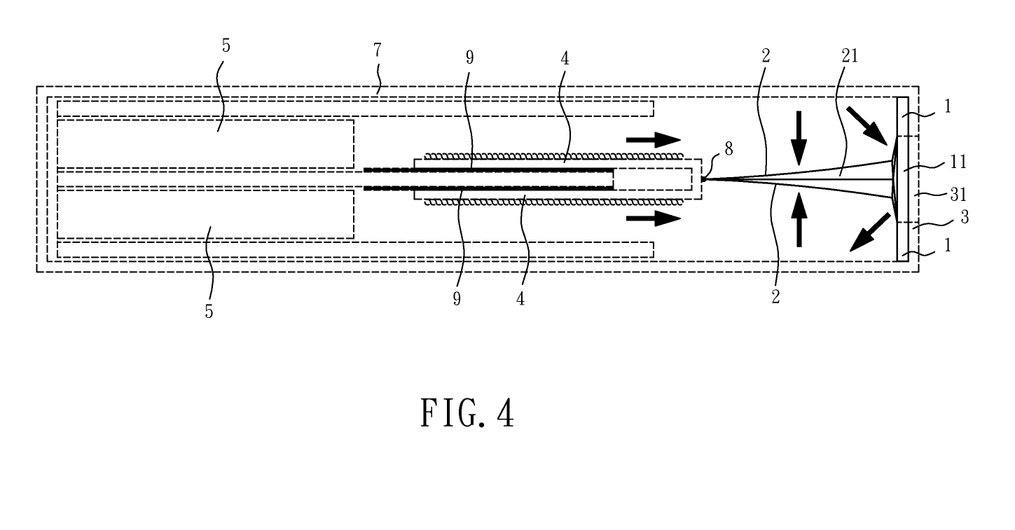

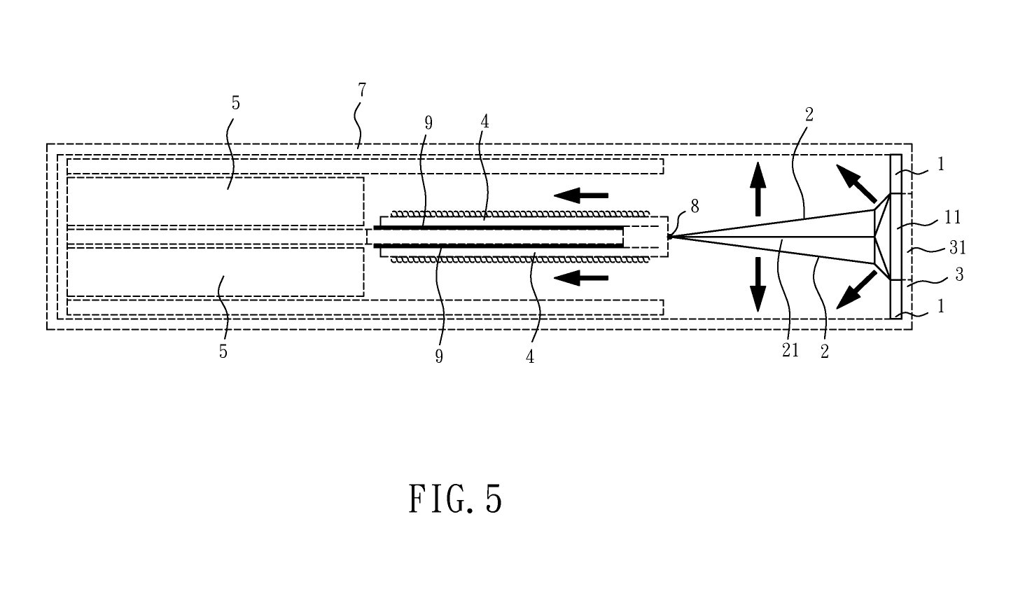

Now, please see FIGS. 1 to 5. In an embodiment of the present invention, an affixing piece 6 is used to affix the voice coil 4 inside the box 7. Therefore, as an alternating current flows through the voice coil 4, the interaction between the magnetic force induced by the current and a magnet 5 would cause the voice coil 4 to move longitudinally. In this motion, as the voice coil 4 moves towards the deformable diaphragm unit 2, a push exerted by this motion would cause the deformable diaphragm unit 2 to contract because the connective portion 1 is fixedly connected with the wall 3. As the voice coil 4 moves towards the magnet 5, a pull exerted by this motion would cause the deformable diaphragm unit 2 to extend. Therefore, such contractions and extensions would cause the deformable diaphragm unit 2 to vibrate in a reciprocating manner and hence generate audible sounds. In addition, as shown in FIGS. 4 and 5, a ferrofluid 9 may be applied on the magnet 5; in this case, there is no need for the use of the affixing piece 6.

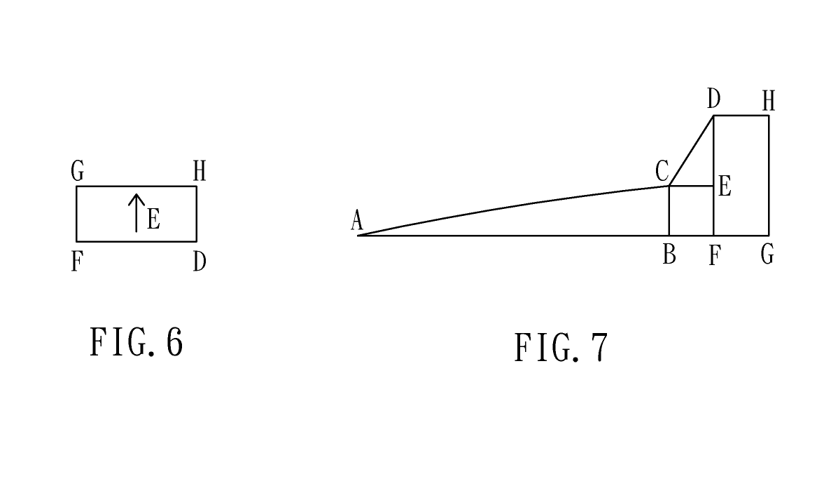

Now, please refer to FIGS. 6 and 7. In the prior art speaker, if the width of a diaphragm is GH and the magnitude of a displacement is GF, then the area of or swept by the displacement would be GH×GF. In the present invention, the area of displacement would be (AB×BC)/2+(EC×ED)/2+BF×FE (because point C moves to point F, point A moves along AF and BF, BF=GF, CD=FD).

Now, we plug numerical values and corresponding ratios into these two equations. In the present invention, AB=10, the angle CDF=45 degree, CD=FD=GH=0.5, BC=FE=CD×(√2−1)/√2, EC=BF=GF=ED=CD/√2.

Therefore,

“The area of displacement of the diaphragm in the prior art speaker”:“The area of displacement of the diaphragm unit in the speaker of the present invention”

=GH×GF:(AB×BC)/2+(EC×ED)/2+BF×FE

=0.5×CD/√2:(10×(CD×(√2−1)/√2))/2+(CD/√2)×(CD/√2)/2+(CD/√2)×(CD×(√2−1)/√2)

=0.5×0.5/√2:(10×(0.5×(√2−1)/√2))/2+(0.5/√2)×(0.5/√2)/2+(0.5/√2)×(0.5×(√2−1)/√2)

=1:4.788

Therefore, because the speaker of the present invention has 4.788 times of the area of displacement, the speaker of the present invention has 4.788 times of the volume of air displacement as compared to the prior art speaker. In addition, because in a unit time, air must pass the same size of opening, air travels 4.788 times fastener in the speaker of the present invention. According to the Newton's kinematics, E=½MV²; therefore, the kinetic energy of air in the speaker of the present invention is 109 times higher (4.788×4.788²=109 because the mass of air becomes 4.788 times too). Therefore, in the speaker of the present invention, the kinetic energy of the audible sounds become 109 times or an increase of 20.3 dB (10 log(109)=20.3 dB).

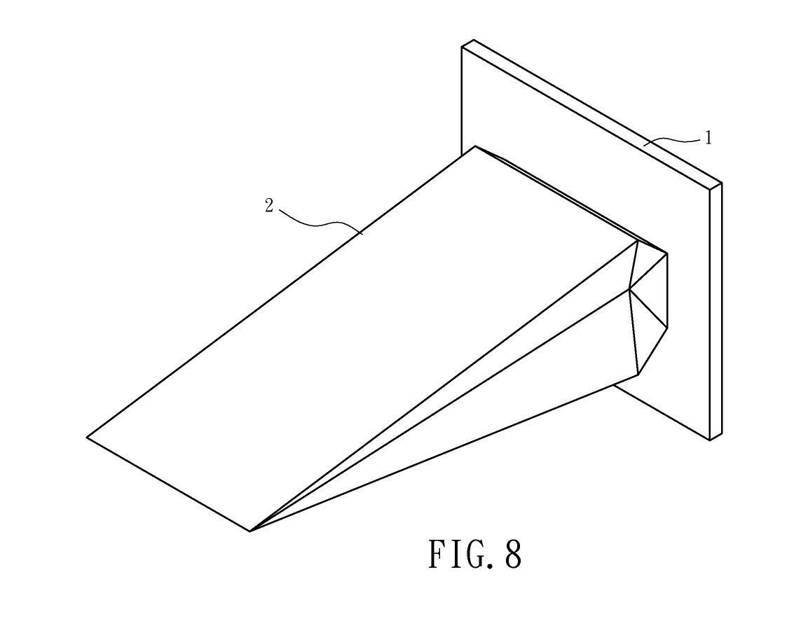

A deformable diaphragm unit in a different shape would operate differently and have a different magnitude of audio output. In FIG. 8, the deformable diaphragm unit 2 has a shape different from the deformable diaphragm unit 2 illustrated from FIGS. 1 to 7. In this embodiment (the third embodiment), air would enter the path 21 as the deformable diaphragm unit 2 moves outwards; as the deformable diaphragm unit 2 moves inwards, air would be squeezed out of the path 21.

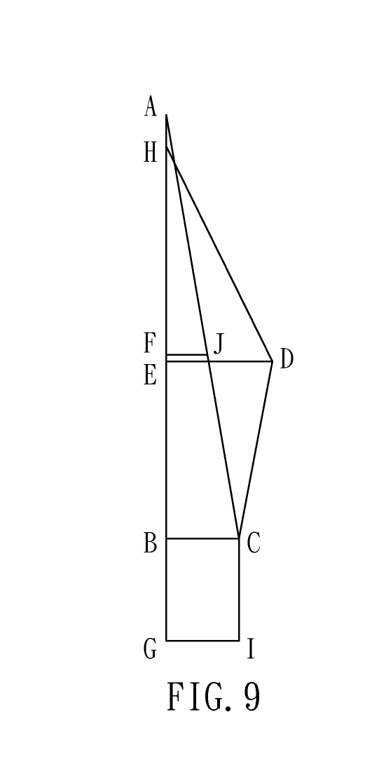

As illustrated in FIG. 9, in a moving coil speaker of the prior art, the width of a diaphragm is BC and the magnitude of a displacement is BG, then the area of or swept by the displacement would be BC×BG. In the third embodiment, CJ=CD, AH=BG and AJ=HD (because it moves from point J to point D and moves from point A to point F; therefore, the area of displacement would be HBCD−ABCD.

Now, we may plug in actual numerical values. In the third embodiment, the area of displacement=HBCD−ABCD=12.19 (because AJ=HD=20.56, angle BAC=2.54 degree, angle BHD=5.58 degree, JC=CD=2, BC=1, angle BCD=120 degree (so AH=BG=0.34)). In the moving coil speaker of the prior art, the area of displacement=BC×BG=0.34. Therefore, the ratio is 12.19:0.34=35.5 times. In addition, because in a unit time, air must pass the same size of opening, the mass of air traveling through the opening in a unit time is 35.5 times more and air travels 35.5 times fastener in the third embodiment speaker of the present invention. According to the Newton's kinematics, E=½MV², the kinetic energy of air in the third embodiment of the present invention is 44,770 times higher (the ratio of kinetic energy=35.5³=44,770). Therefore, in the speaker of the present invention, the kinetic energy of the audible sounds becomes 44,770 times higher or an increase of 20.3 dB (10 log (44,770)=46.5 dB).

From the above, we can see that the electrical signal to audio signal transducer with a deformable diaphragm unit of the present invention meets the relevant patent requirements. It is hoped that the patent application will be approved.

Many changes and modifications in the above described embodiments of the invention can, of course, be carried out without departing from the scope thereof. Accordingly, to promote the progress in science and the useful arts, the invention is disclosed and is intended to be limited only by the scope of the appended claims.

What is claimed is:

1. An electrical signal to audio signal transducer with a deformable diaphragm unit, disposed in a box and connected with a wall of the box, comprising:
a connective portion, in which a through opening is provided, characterized in that the outer side of the connective portion is connected with a wall of the box; and
a deformable diaphragm unit, characterized in that the inner side of the connective portion is connected with the deformable diaphragm unit to form a path and that the inner side of the deformable diaphragm unit is connected with a voice coil.

2. The electrical signal to audio signal transducer with a deformable diaphragm unit as in claim 1, wherein the deformable diaphragm unit comprises at least one diaphragm and is a partial enclosure entity.

3. The electrical signal to audio signal transducer with a deformable diaphragm unit as in claim 1, wherein the inner side of the deformable diaphragm unit is connected with a voice coil at at least an affixing point, which is formed by glue or soldering.

4. The electrical signal to audio signal transducer with a deformable diaphragm unit as in claim 1, wherein an opening is provided in the wall of the box, characterized in that when the connective portion is connected with the wall, the through opening should be aligned with the opening of the wall.
